(19) United States
(12) Patent Application Publication
(10) Pub. No.: US 2012/0291888 A1
(43) Pub. Date: Nov. 22, 2012

(54) UNDULATING SEALING SURFACE WITH RAISED RIDGE

(75) Inventors: Daren Bane, Broken Arrow, OK (US); John Gunnells, Broken Arrow, OK (US)

(73) Assignee: BAKER HUGHES INCORPORATED, Houston, TX (US)

(21) Appl. No.: 13/112,692

(22) Filed: May 20, 2011

(51) Int. Cl. F16K 15/00

(52) U.S. Cl. 137/511

(57) ABSTRACT

A valve assembly including a first member having a first undulating sealing surface, the first undulating sealing surface having a ridge extending therefrom, a second member having a second undulating sealing surface, the first and second undulating sealing surfaces being complementarily formed, the second member having a seal element for sealing the valve assembly when the first and second members are engaged, the ridge operatively arranged to increase a contact pressure between the first member and the seal element.

### BACKGROUND

Valves are known in the drilling and completion arts for selectively preventing or enabling a flow of fluid or the like through the valve. Subsurface safety valves are commonly used in these arts. Under low pressure scenarios, valves, such as flapper valves, do not always create an adequate seal as fluid pressure against the flapper is utilized as a part of the energy that causes the sealing effect of the valve. As a result, the industry is always desirous of new valve features with the aim of providing an improved seal.

### BRIEF DESCRIPTION

A valve assembly including a first member having a first undulating sealing surface, the first undulating sealing surface having a ridge extending therefrom, a second member having a second undulating sealing surface, the first and second undulating sealing surfaces being complementarily formed, the second member having a seal element for sealing the valve assembly when the first and second members are engaged, the ridge operatively arranged to increase a contact pressure between the first member and the seal element.

### BRIEF DESCRIPTION OF THE DRAWINGS

The following descriptions should not be considered limiting in any way. With reference to the accompanying drawings, like elements are numbered alike:

FIG. 1 schematically illustrates a perspective view of a flapper valve assembly in an open position;

FIG. 2 schematically illustrates an enlarged view of a ridge on a sealing surface of the flapper taken generally along line 2-2 of FIG. 1;

FIG. 3 schematically illustrates the ridge of the flapper of FIGS. 1 and 2 being aligned for engagement with a seal element of a valve seat; and

FIGS. 4-6 schematically illustrate variables for deriving an equation for forming an undulating sealing surface.

### DETAILED DESCRIPTION

A detailed description of one or more embodiments of the disclosed apparatus and method are presented herein by way of exemplification and not limitation with reference to the Figures.

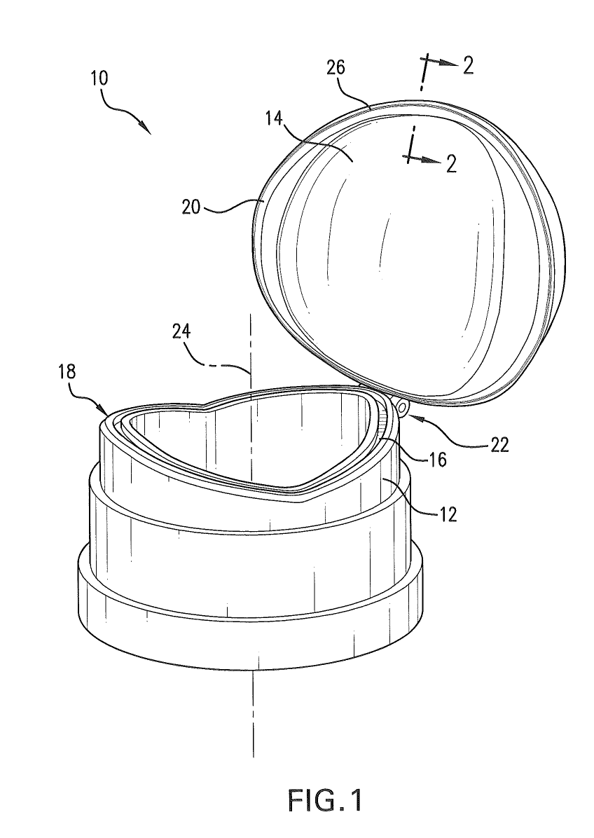

Referring to FIG. 1, it can be seen that a valve assembly 10 includes a seat 12 and a flapper 14. The seat 12 includes a groove 16, which extends around the entire periphery of the seat 12. The groove 16 is formed in a sealing surface 18 of the seat 12. The flapper 14 includes a sealing surface 20 that is complementarily formed for mating engagement with the sealing surface 18 of the valve seat 12. The sealing surfaces 18 and 20 are undulating and/or sinusoidal, as will be described in more detail below. In one embodiment, as indicated in FIG. 1, the sealing surfaces 18 and 20 are each formed in an undulating plane transverse to a longitudinal axis 24 around the entire periphery. The flapper 14 includes a hinge 22 in order to enable the flapper 14 to rotate with respect to the seat 12 in order to open and close the valve 10.

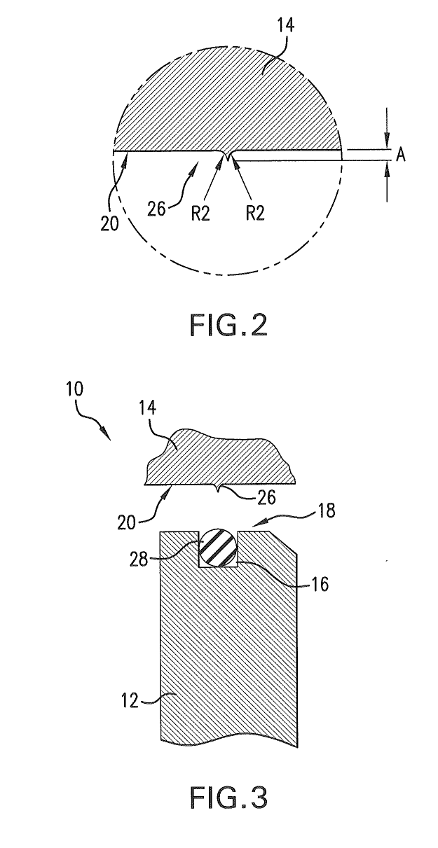

The sealing surface 20 of the flapper 14 includes a ridge 26 for providing improved sealed engagement between the flapper 14 and the seat 12. The ridge 26 is shown in more detail in FIGS. 2-3. The ridge 26 is formed as a relatively small bump, lip, ridge, crest, protrusion, etc. extending axially from the sealing surface 20 of the flapper 14. The ridge 26 could be pointed, rounded, flattened, etc. In FIG. 2, the ridge 26 has an axial height A and is pointed as a result of the radially inner and outer edges of the ridge 26 being radiused by a radius R2.

As shown in FIG. 3, the ridge 26 is aligned with a seal element 28. The seal element 28 is shown disposed in the groove 16 of the seat 12. The seal element 28 is, for example, a polytetrafluoroethylene seal, or some other resilient seal element. When the flapper is closed (it is partially opened in FIG. 3), the ridge 26 will “bite” into the seal 28, which improves sealing performance, particularly low pressure sealing performance, of the flapper 14 and the seat 12. Alternatively stated, the ridge 26 is included to increase the contact pressure between the flapper 14 and the seal element 28, thus enabling improved sealed engagement of the flapper 14 and the seat 12 of the valve assembly 10. In one embodiment, the radii R2 are approximately in the range of 0.03 inches, while the axial height A is approximately in the range of 0.010 to 0.015 inches. Of course, smaller or larger ridges could also be used, depending on the particular conditions in which the valve assembly 10 is used, although it is to be noted that making the ridge 26 too large may not significantly increase contract pressure, while making the ridge 26 too small may not provide enough material or durability to seal properly or repeatedly.

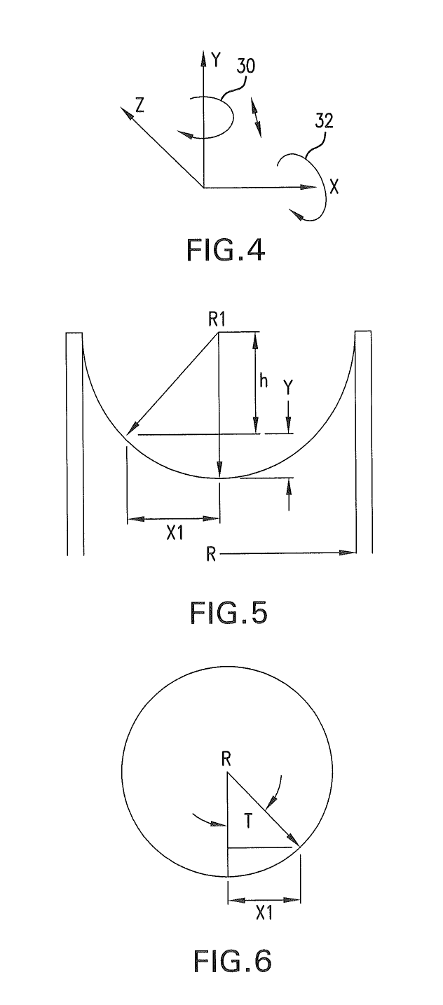

Manufacture of the sealing surfaces 18 and 20 of the seat 12 and flapper 14 will be better appreciated in view of FIGS. 4-6. In FIG. 4, the X-axis represents the centerline of the cutting tool and an arrow 30 the direction of the rotation of the cutting tool. The milling machine holds the piece along the Y-axis and is capable of advancing along the Y-axis, while at the same time rotating it in the direction shown by an arrow 32. It will be noted that the longitudinal axes of the cutting tool and the piece being cut are perpendicular with respect to each other. The piece to be cut on the Y-axis, whether it is a seat or a flapper (e.g., the seat 12 or the flapper 14), is engaged in a machine and rotated and fed along the Y-axis with respect to the cutter, which rotates along the X-axis as indicated by the arrow 30.

FIGS. 3-6 illustrate one embodiment of relationships that can be used to program a computer-controlled milling machine in order to produce a sealing surface, which is generally flat, to the longitudinal axis of the seat and the flapper. The significant variables which dictate the positioning of the piece with respect to the cutter are as follows: X1 dictates the rotational movement required about the Y-axis of the piece with respect to the rotating cutter; R is the inside radius of the sealing (e.g., the surface 18 or 20); R1 is an intersecting radius; and the variable Y illustrates the movement along the Y-axis of the piece with respect to the rotating cutter. Using algebra and known geometric relationships, the variables X and Y can be calculated in terms of known quantities and the machine can be programmed accordingly. The derivation is given in FIG. 5: h+Y=R1; Y=R1−h ; h²+X1²=R1²; h=(R1²−X²)^{0.5}; Y=R1−(R1²−X1²)^{0.5} and in view of FIG. 6, with T expressed in radians: sin(T)=X1/R; X1=R*sin(T); Y=R1−{R1²−[R*sin(T)]²}^{0.5}; circumference (C)=R*T(2π radians), cord length (X)=R*T(radians) for unwrapped X position on circumference; X=R*T.

As a result of using these techniques, a seat or flapper can be produced having a sinusoidal or other undulating profile, throughout the 360 degree extent of the surface, where the sealing surfaces are presented in a transverse plane to the longitudinal axis of the seat and the flapper when placed in a mating closed position.

While the profile of the seat when extended into a two-dimensional plane can be a true sinusoid, modification of a true sinusoid is also within the scope of the invention. In fact, a succession of undulating curves, each forming a segment of a circle having a finite radius, can also be used to create the undulating shape of the seat and the matching flapper. It is also to be appreciated that although the flapper 14 is shown having the ridge 26, that in other embodiments, the flapper could include a groove and a seal element, while a ridge is disposed on the seat.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A valve assembly, comprising:
a first member having a first undulating sealing surface, the first undulating sealing surface having a ridge extending therefrom;
a second member having a second undulating sealing surface, the first and second undulating sealing surfaces being complementarily formed, the second member having a seal element for sealing the valve assembly when the first and second members are engaged, the ridge operatively arranged to increase a contact pressure between the first member and the seal element.

2. The valve assembly of claim 1, wherein the first member is a flapper and the second member is a seat for the flapper.

3. The valve assembly of claim 1, wherein the second member is a flapper and the first member is a seat for the flapper.

4. The valve assembly of claim 1, wherein the first and second undulating sealing surfaces are sinusoidal.

5. The valve assembly of claim 1, wherein the seal element is disposed in a groove in the second member.

6. The valve assembly of claim 1, wherein the ridge comes to a point.

7. The valve assembly of claim 5, wherein edges of the ridge are radiused by radii in a range of approximately 0.03 inches.

8. The valve assembly of claim 1, wherein the ridge has an axial height in a range of approximately 0.010 to 0.015 inches.
